(19) United States
(12) Patent Application Publication
(10) Pub. No.: US 2008/0240883 A1
(43) Pub. Date: Oct. 2, 2008

(54) Threaded Insert and Method of Using Same

(75) Inventor: Mark Joseph Walling, Grand Haven, MI (US)

Correspondence Address: FULBRIGHT & JAWORSKI L.L.P., 80 SOUTH EIGHTH STREET, SUITE 2100, MINNEAPOLIS, MN, 55402, US

(73) Assignee: TENNANT COMPANY, Minneapolis, MN (US)

(21) Appl. No.: 12/059,976

(22) Filed: Mar. 31, 2008

Related U.S. Application Data
(60) Provisional application No. 60/909,260, filed on Mar. 30, 2007.

(51) Int. Cl. F16B 37/12; F16B 23/00; F16B 25/10; F16B 39/00; F16D 1/00; G06F 19/00

(52) U.S. Cl. 411/178; 411/403; 411/387.4; 411/166; 411/103; 403/408.1; 700/95

(57) ABSTRACT

The present invention is directed to a threaded insert having an internal threaded surface and an external threaded surface. The threaded surfaces have threads that are threaded in opposite directions. Thus, if the internal threaded surface is a right handed thread, then the external threaded surface will be a left handed thread. Through the use of the opposite direction threads the insert counteracts torque applied to a threaded fastener as it is inserted or removed. This results in a threaded insert that both resists over tightening of the fastener, and assists in the removal of the fastener from the insert.

### TECHNICAL FIELD

This application claims priority under 35 U.S.C. 119(e) from provisional U.S. Patent Application No. 60/909,260 filed Mar. 30, 2007, the contents of which are incorporated herein by reference.

### TECHNICAL FIELD

The present invention relates to threaded inserts for connecting fastening devices to other components. More specifically, the present invention relates to a threaded insert for connecting a fastening device into a component material where corrosion or seizing is likely to occur.

### BACKGROUND OF THE INVENTION

Threaded inserts are commonly used to provide strength or prevent damage to soft or lightweight materials where a threaded fastener or other item is repeatedly inserted and removed from the material. Threaded inserts are placed in the associated material of a parent part such that the fastener can be inserted into the threaded insert. The threaded insert may be molded directly into the material. However, in other approaches the insert is screwed or otherwise rotated into the parent material. Once the threaded insert is connected to the parent material the fastener can be rotated into the insert, thereby connecting the fastener to the parent part. Often, the fastener is designed to be removed and reinserted into the threaded insert multiple times without causing damage to the underlying parent part. However, the design of typical inserts makes it difficult to remove fasteners that have become frozen, corroded, or otherwise locked into the insert without damaging the underlying parent material. Further, the design of many inserts makes it difficult to remove the insert from the material when recycling.

### BRIEF SUMMARY OF THE INVENTION

The present invention is directed to a threaded insert having an internal threaded surface and an external threaded surface. The threaded surfaces have threads that are threaded in opposite directions. Thus, if the internal threaded surface is a right handed thread, then the external threaded surface will be a left handed thread. Through the use of the opposite direction threads the insert counteracts torque applied to a threaded fastener as it is inserted or removed. This results in a threaded insert that both resists over tightening of the fastener, and assists in the removal of the fastener from the insert.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A is a perspective view of a threaded insert according to one embodiment;

FIG. 1B is a cut away view of a threaded insert;

FIG. 2A is a partial cut away view of a threaded insert molded into a parent component and a fastener;

FIG. 2B is a partial cut away view of a threaded insert inserted into a parent component and a fastener;

FIG. 2C is a cut away view of a threaded insert molded into a parent component, a threaded fastener and a removable component;

FIG. 2D is a cut away view of a threaded insert inserted into a material and a fastener; and

FIG. 3 is a perspective view of a threaded insert according to an alternative embodiment.

### DETAILED DESCRIPTION OF THE INVENTION

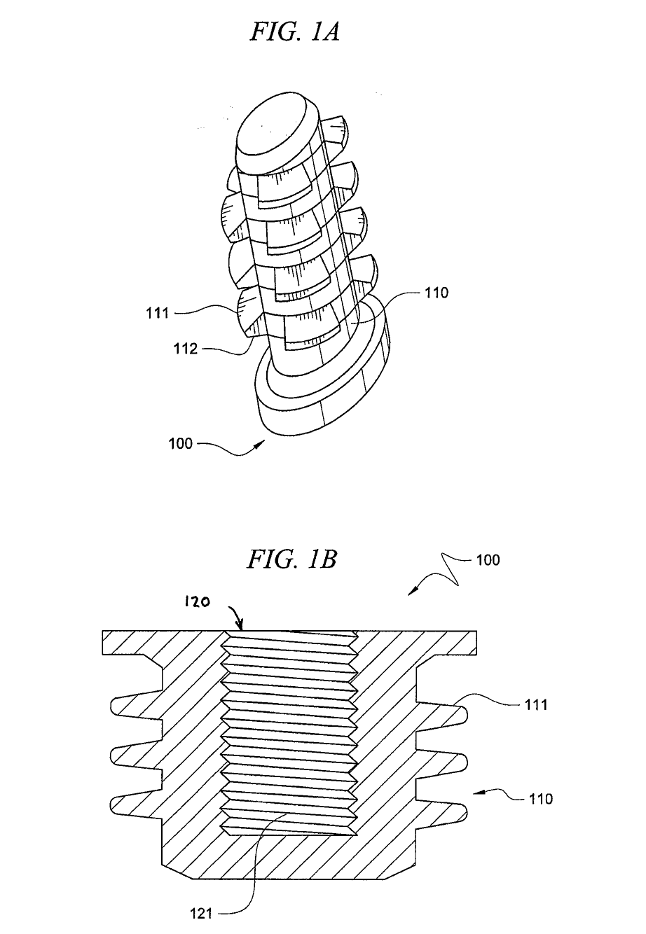

FIG. 1A is a perspective view of a threaded insert 100 according to at least one embodiment of the present invention. FIG. 1B is a cutaway view of threaded insert 100 according to at least one embodiment. For purposes of this discussion FIGS. 1A and 1B will be discussed together. Threaded insert 100 has an external threaded surface 110 and an internal threaded surface 120. In contrast to previous threaded inserts the external threaded surface 110 is threaded in a direction opposite the direction of threading of the internal threaded surface 120.

In one embodiment, insert 100 is placed in a soft material such as plastic or aluminum where the repeated insertion and removal of an item, such as a fastener, directly into the material could damage the material. One embodiment of the design of insert 100 is especially advantageous in environments where corrosion is likely. Further, in one embodiment, insert 100 is formed as a zinc die cast and includes a 96+ hour salt spray corrosion resilient trivalent zinc plating. However, other materials can be used for insert 100.

In one embodiment external threaded surface 110 includes thread 111, and internal threaded surface 120 includes thread 121. Thread 111 and thread 121 are in one embodiment helical ridges that are disposed on surfaces 110 and 121. Threads 111 and 121 can be formed, for example, cutting into the surface or during casting or molding of insert 100. In one embodiment, thread 111 is a left handed thread, and thus thread 121 is a right handed thread. However, in other embodiments the direction of the threads can be reversed. In one embodiment, thread 111 has a pitch that is greater than the pitch of threads 121 on the internal surface. The arrangement of thread 111 versus thread 121 acts to counteract torque imparted by a threaded fastener as it is inserted into the insert.

When placing threaded insert 100 into a material several approaches can be used. In one embodiment, insert 100 is rotated into the parent component. In this embodiment, insert 100 can be placed in a pre-bored hole that has been formed in the parent component, or can be a self drilling insert. In another embodiment, insert 100 is a self-tapping insert. In yet another embodiment, insert 100 is placed or molded in the parent material during manufacturing. However, other methods can be used.

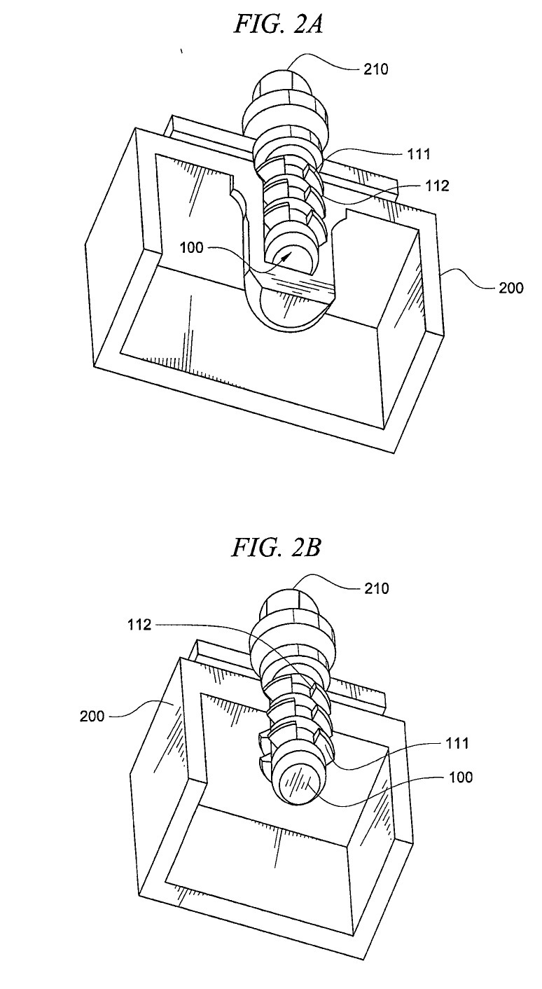

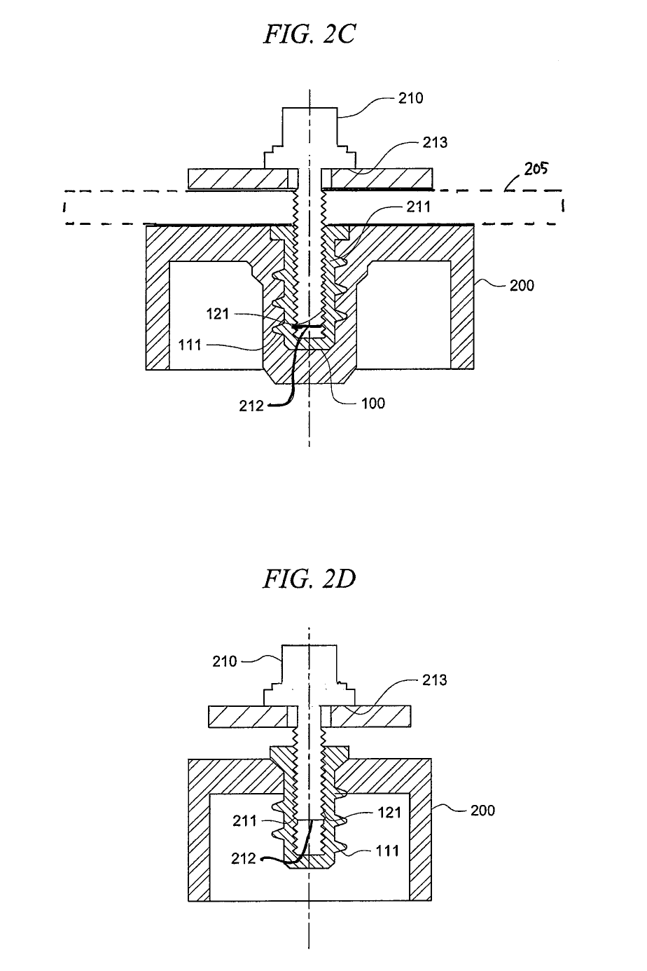

In one illustrative embodiment, thread 111 includes discontinuities or notches 112 in the thread that provide additional torque resistance when molded or rotated into a material. Depending on the method of insertion of the insert (molding or rotating) the notches operate in a slightly different manner in the material. In embodiments where insert 100 is molded into the material, notches 112 are surrounded by the molded material of the parent component. An insert 100 molded into the parent component 200 is illustrated in FIG. 2A. This surrounding of parent component 200 provides additional torque resistance by hindering the rotation of the insert. In embodiments where the insert is rotated into the parent component, as illustrated for example in FIG. 2B, the notches assist in holding the insert into the component or provide exit paths for material when self tapping.

The threaded insert according to at least one embodiment of the present invention protects the underlying material during insertion of a threaded fastener 210 into the threaded insert 100. During insertion threaded fastener 210 is rotated in such a manner that threads 211 of the fastener engage internal threads 121 of insert 100 as illustrated in FIGS. 2C and 2D.

FIG. 2C illustrates removable component 205 connected to parent component 200 via threaded fastener 210 and insert 100. In this example, threaded fastener 210 is passed through an aperture of removable component 205. As threaded fastener 210 is rotated within insert 100, removable component 205 and parent component 200 are drawn together.

When end 212 of the fastener 210 reaches the bottom (stop surface) of thread 121 additional rotation of fastener 210 does not result in the additional tightening of the fastener 210 relative to the parent component 200 or removable component 205. Instead, this rotational force is transferred to the insert 100 and causes insert 100 to rotate in a direction that would tend to remove the insert 100 from parent component 200. Thus, the insert 100 acts to prevent over tightening of the fastener 210. A similar function may be achieved by interaction between the other stop surface(s), the insert 100 and the fastener 210.

According to at least one embodiment, insert 100 is also designed to assist in the removal of fastener 210, especially when the fastener has become fused or otherwise stuck in insert 100. This usually occurs in environments where the fastener is likely to corrode such as high salt or high moisture areas. When removing fastener 210, the fastener is rotated, for example, in an anti-clockwise direction. The anti-clockwise rotation of fastener 210 causes threads 211 of fastener 210 to travel along internal threads 121 of insert 100 such that fastener backs out of insert 100. At the same time if the fastener has become fused to the insert the anti-clockwise rotation acts to cause external threads 111 to rotate insert 100 into component 200. This creates an additional forces tending to release the fastener from the insert, while at the same time preventing the insert from breaking free from the material, and being removed from the material along with the fastener.

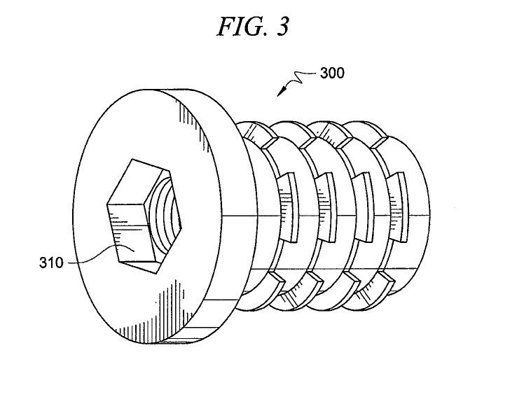

FIG. 3 is a perspective view of threaded insert 300 according to one embodiment of the present invention. In this embodiment threaded insert 300 includes a blind internal thread. However, other types of threads can be used. The blind internal thread assists in keeping contaminates (such as plastic powder) out of the internal threads during molding of the material around the insert, or during the insertion of the insert into the parent component.

Insert 300 also includes a torque coupling area 310. Torque coupling area 310 assists in the insertion and/or removal of insert 300 from the parent component. Typically, the need to remove the insert arises from damage to the part during use or during the manufacturing process of the associated part. In prior art approaches the insert is removed using a costly and unsafe routering process to free the insert from the part. In one embodiment, torque coupling area 310 is a recessed area that is recessed into a portion of the insert. In the embodiment illustrated in FIG. 3 the recessed area is a hex recess. The hex recess area allows the insert to be rotated when a corresponding hex is placed in the recess. However, other interfaces can be used, such as a flat head or Phillips head screwdriver interface. The torque coupled area and the external threads provide a simpler and safer means for recovering the insert 300 from the part prior to recycling. However, in other embodiments torque coupling area 310 can be a configured perimeter to assist in the insertion/removal of the insert. In these embodiments the configured perimeter can be arranged such that the insert can be engaged by a wrench or socket. Typically, the configured perimeter is raised above a top surface of the material. However, other configurations can be used.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An assembly for connecting a removable component to a parent component via a threaded fastener, said assembly comprising:
a threaded insert at least partially received into the parent component and having a threaded internal surface and a threaded external surface and wherein said external surface is threaded in an opposite direction from said internal surface,
wherein the threaded fastener is adapted to draw the removable component and parent component together as said threaded fastener is turned in a first direction, and whereupon said threaded fastener contacting a stop surface, further rotation of said threaded fastener causes the threaded insert to rotate out of contact with the parent component.

2. The assembly of claim 1 wherein said threaded external surface comprises a left handed thread and said threaded internal surface comprises a right handed thread.

3. The assembly of claim 1 wherein said threaded external surface comprises a right handed thread and said threaded internal surface comprises a left handed thread.

4. The assembly of claim 1 wherein a thread of said threaded external surface has a pitch that is greater than a pitch of a thread of said threaded internal surface.

5. The assembly of claim 1 wherein said threaded external surface comprises a discontinuous thread.

6. The assembly of claim 5 wherein said threaded external surface includes a plurality of notches disposed in said discontinuous thread.

7. The assembly of claim 1 further comprising:
a torque coupling structure disposed about a top portion of said threaded insert; said torque coupling structure configured to engage a torque providing device in order to rotate said threaded insert.

8. The assembly of claim 7 wherein said torque coupling structure is a recessed component configured to receive a portion of said torque providing device.

9. The assembly of claim 7 wherein said torque coupling structure is a configured perimeter.

10. The assembly of claim 7 wherein said threaded insert is self-tapping.

11. The assembly of claim 7 wherein a portion of said threaded insert has an outer diameter that is greater than an outer portion of said threaded external surface.

12. The assembly of claim 1 wherein said threaded insert is molded into a parent material.

13. The assembly of claim 1 wherein said stop surface is a bottom surface of an aperture containing the threaded insert.

14. The assembly of claim 1 wherein said stop surface is a top surface of the threaded insert.

15. The assembly of claim 1 wherein said internal surface defines a closed-bottomed aperture.

16. A method of using the assembly of claim 1 comprising:
rotating the threaded insert into the parent component in a second direction opposite said first direction;
passing the threaded fastener through the removable component; and
rotating in said first direction, said threaded fastener into said threaded insert.

17. The method of claim 16 further comprising:
releasing the removable component from the parent component by removing the threaded fastener from said threaded insert.

18. The method of claim 17 wherein upon said fastener contacting said stop surface, further rotation of said fastener causes rotation of said threaded insert and reverses said insert out of said parent material.

19. An assembly comprising:
a parent component;
a removable component;
a threaded insert at least partially disposed in said parent material and having an internal threaded surface and an external threaded surface in engagement with the parent material, wherein said external threaded surface is threaded in an opposite direction from said internal threaded surface; and
a threaded fastener passing through at least a portion of the removable component and having threads sized to engage the internal threaded surface of the insert, wherein rotation of the fastener in a first direction initially causes the removable component and parent component to be drawn together, and wherein further rotation of the fastener in the first direction causes the threaded insert to back out of engagement with the parent component.

20. The assembly of claim 19 wherein said threaded insert is molded into said parent component.

21. The assembly of claim 19 wherein said threaded insert is rotated into said parent component.

22. The assembly of claim 21 wherein said threaded insert includes a plurality of notches disposed in said external threaded surface; and wherein said plurality of notches engage portions of said parent component.
